(19) United States
(12) Patent Application Publication
(10) Pub. No.: US 2005/0004284 A1
(43) Pub. Date: Jan. 6, 2005

(54) Compounds suitable as dispersion agent for pigments

(76) Inventors: Martin Koenemann, Mannheim (DE); Cordula Mock-Knoblauch, Ludwigshafen (DE); Frank Funke, Mannheim (DE); Ulrike Hees, Mannheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/495,751

(22) PCT Filed: Dec. 2, 2002
(86) PCT No.: PCT/EP02/13573

(30) Foreign Application Priority Data
Dec. 4, 2001 (DE) 10159315.5

(51) Int. Cl. C08L 1/00

(52) U.S. Cl. 524/236; 528/425; 528/367

(57) ABSTRACT

The invention relates to compounds suitable as dispersion agent for pigments, of general formulae (I) to (III): R¹—X—[—CO—NH—R²—NH—CO—Y—R³—Y—]ᵣ—CO—NH—R²—NH—CO—X—R¹ (I); R¹—X—[—CO—NH—R²—NH—CO—Y—R³—Y—]ᵣ—CO—NH—R⁴ (II); R¹—X—[—CO—NH—R²—NH—CO—Y—R³—Y—]ᵣ—CO—NH—R²—NH—CO—Z—R⁵ (III), where R¹=an alkyl-capped oligoalkylenoxide residue of general formula (IV): R⁶O—(—CH₂—CH₂—O—)ₐ—(R⁷—O—)_{b}— (IV), and X, Y and Z each=O or NH, R²=arylene or arylalkylene group on a diisocyanate, R³=alkylene, arylene or arylalkylene group on a diol or diamine, R⁴=alkyl, aryl or arylalkyl group on a monoisocyanate, R⁵=alkyl, aryl or arylalkyl on a monoalcohol or monioamine, R⁶=alkyl with 1 to 4 C atoms, R⁷=branched alkylene group with 3 to 8 C atoms, r=a rational number from 0 to 100, a=a whole number from 1 to 300 and b=a whole number from 0 to 30.

This invention relates to compounds of the general formulae I to III
R¹—X—[—CO—NH—R²—NH—CO—Y—R³—Y—]ᵣ—CO—NH—R²—NH—CO—X—R¹ (I)
R¹—X—[—CO—NH—R²—NH—CO—Y—R³—Y—]ᵣ—CO—NH—R⁴ (II)
R¹—X—[—CO—NH—R²—NH—CO—Y—R³—Y—]ᵣ—CO—NH—R²—NH—CO—Z —R⁵ (III)

where R¹ is an alkyl-capped oligoalkylene oxide radical of the general formula IV
R⁶O—(—CH₂—CH₂—O—)ₐ—(—R⁷—O—)_{b}— (IV)

where

X is O or NH

Y is O or NH

Z is O or NH

R² is an arylene or aralkylene radical of an aliphatic, aromatic or aromatic-aliphatic diisocyanate OCN—R²—NCO,

R³ is an alkylene, arylene or aralkyl radical of an aliphatic, aromatic or aromatic-aliphatic diol HO—R³—OH for Y being O or a diamine H₂N—R³—NH₂ for Y being NH,

R⁴ is an alkyl, aryl or aralkyl radical of an aliphatic, aromatic or aromatic-aliphatic monoisocyanate R⁴—NCO,

R⁵ is an alkyl, aryl or aralkyl radical of an aliphatic, aromatic or aromatic-aliphatic monoalcohol R⁵—OH for Z being O or a monoamine R⁵—NH₂ for Z being NH,

R⁶ is alkyl of 1 to 4 carbon atoms,

R⁷ is branched alkylene of 3 to 8 carbon atoms,

r is a rational number from zero to 100,

a is an integer from 1 to 300, and

b is an integer from zero to 30.

The compounds having the general formula I are hereinafter referred to as compounds I for short, the compounds having the general formula II are hereinafter referred to as compounds II for short, and the compounds having the general formula III are hereinafter referred to as compounds III for short.

The present invention further provides a process for preparing the compound I, a process for preparing the compounds II and a process for preparing the compounds III, the use of these compounds I, II and III as dispersants for pigments and also as process chemicals in pigment manufacture, and also pigment preparations including these compounds I, II or III. The present invention also provides for the use of these pigment preparations for water-containing coatings and paints, in particular waterborne coatings. The present invention finally provides water-containing coatings, water-containing printing inks, water-containing paints and waterborne coatings that include these pigment preparations.

Pigment preparations include dispersant additives to improve the rheological and color properties of the pigments. In aqueous paints in particular, dispersant additives are intended to facilitate the dispersion of the pigments and inhibit coagulation, flocculation or sedimentation of the pigments during the storage of the ready-produced paint.

U.S. Pat. No. 4,929,279 describes a process for dispersing an organic pigment in an aqueous phase by using salts of certain propane-diamines or polyethylene oxides as a dispersant-surfactant.

EP-A 154 678 discloses pigment dispersants prepared by reacting polyisocyanates first with monohydroxy compounds, then with, inter alia, polyols such as polyalkylene glycols for example and finally with heterocyclic compounds. Monoterminally alkyl-capped polyols (HO—R—OR′) are not mentioned.

DE-A 2 906 111 teaches pigment preparations including urea derivatives of the formula K—(—NH—CO—NH—R)₂ where K is 1,5-naphthylene or 4,4′-diphenylmethane and R may be —(CH₂)₃—O—(C₂H₄O)ₙ—O—R¹ (where n is 1, 2, 3 or 4, R¹ is C₂-C₈-alkyl or phenyl). In contrast to the compounds of the present invention, which have a branched alkylene radical R⁷, the propylene radical —(CH₂)₃— is linear in this reference.

EP-A 555 950 describes aqueous pigment dispersions where the dispersant ingredient is a polycyclic aromatic compound having a polyalkylene oxide side chain, for example ethoxylated 1- or 2-naphthol.

WO-A 99/41320 discloses ink jet inks containing polyurethane dispersants having, for example, polyalkylene oxide (for instance, polyethylene glycol methyl ether) as a dispersing group. However, the polyurethanes contain ionic groups, especially carboxyl groups.

DE application 10147404.0, unpublished at the priority date of the present invention, describes polyurethane block copolymers for preparing dispersing binders that may contain hydrophilic end groups. However, the end groups contain an —OH group in the terminal position and not, like the compounds of the present invention, —O(alkyl). For this reason, the polyurethane block copolymers are partially crosslinkable.

The prior art compounds do not improve the color and Theological properties of the pigment preparations to a sufficient degree for all applications. More particularly, the dispersibility of the pigments is not always sufficiently improved by the prior art dispersants.

In addition, the known compounds have comparatively low melting or softening points and are liquid or pasty, which is why the pigment formulations prepared therewith become doughy and gooey. Doughy or gooey pigment formulations are not uniformly incorporable in the coating to be pigmented.

Moreover, in the known liquid dispersant media, some pigments are susceptible to undesirable recrystallization coupled with disadvantageous particle growth.

Furthermore, the known dispersants only permit the production of relatively low-pigment formulations, ie pigment formulations having a high pigment volume concentration cannot be produced. Finally, the known compounds can be used in pigment manufacture only with limited success, if any. More particularly, the known liquid dispersants cannot be used in some important operations of pigment manufacture such as dry ball milling.

It is an object of the present invention to remedy the disadvantages described. More particularly, it is an object of the present invention to provide compounds which, when used as pigment dispersants, improve the color properties (color strength, chroma, transparency, etc) and the Theological properties (including yield point, viscosity) of the pigment preparations.

It is a further object of the present invention to provide compounds which improve the dispersibility of the pigments.

The compounds shall moreover not cause the pigment preparations to become gooey or doughy, even when included in the preparation in a relatively high concentration. Pigment recrystallization shall be controlled.

Moreover, the compounds shall make it possible to prepare high-pigment preparations as well.

The compounds shall lastly also be useful in pigment manufacture, for example as assistants at the synthesis or crystallization stage, as assistants in the wet treatment (eg wet grinding, kneading, suspension) or dry grinding, and also as assistants at the drying stage (eg to reduce agglomeration during drying and during dry grinding).

We have found that these objects are achieved by the compounds defined at the beginning.

The present invention further provides a process for preparing the compound I, a process for preparing the compounds II and a process for preparing the compounds III, the use of these compounds I, II and III as dispersants for pigments and also as process chemicals in pigment manufacture, and also pigment preparations including these compounds I, II or III. The present invention also provides for the use of these pigment preparations for coloring water-containing coatings, printing inks and paints, in particular waterborne coatings, and also water-containing coatings, water-containing paints and waterborne coatings that include these pigment preparations.

Preferred embodiments of the invention are discernible from subsidiary claims.

In contrast to the aforementioned WO-A 99/41320 reference, the compounds of the present invention do not contain ionic groups such as carboxylate, phosphate, phosphonate, sulfonate or quaternary ammonium (see WO-A 99/41320 page 9 line 29-page 10 line 4 and page 15 line 14-page 17 line 9).

The compounds of the general formula I
R¹—X—[—CO—NH—R²—NH—CO—Y—R³—Y—]ᵣ—CO—NH—R²—NH—CO—X—R¹ (I)
have an ABA block structure in which the alkyl-capped oligoalkylene oxide radicals R¹ constitute the A blocks and the internal structure —X—[—CONH—R²—NHCO—Y—R³—Y—]ᵣ—CONH—R²—NHCO—X—constitutes the B block:

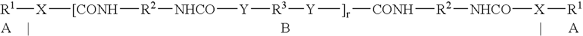

When X is O or Y is O, there is a urethane group (carbamate group) V,

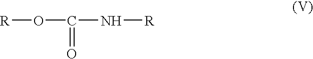

and when X is NH or Y is NH, there is a urea group VI

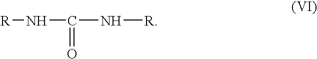

The meaning of the variables X and Y in the above formula I (O or NH) follows from the starting materials, see hereinbelow.

Preferably either each X is O or each X is NH (and not, for instance, one X being O and one X being NH). The same holds for Y, mutatis mutandis. However, each X and each Y can both be O or NH, or each X can both be O and each Y can both be NH, or each X can both be NH and each Y can both be O.

The starting materials from which the compounds I are prepared will now be described.

R² is the arylene or aralkylene radical of respectively an aliphatic, aromatic or aromatic-aliphatic diisocyanate OCN—R²—NCO. Useful diisocyanates OCN—R²—NCO include in particular:

hexamethylene diisocyanate (HDI), R²: —(—CH₂—)₆—

naphthylene 1,5-diisocyanate (NDI); R²:

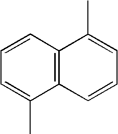

tolylene 2,4-diisocyanate (TDI); R²:

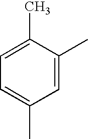

tolylene 2,6-diisocyanate (TDI); R²:

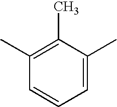

methylene diphenyl diisocyanate (MDI);

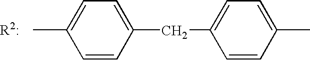

tetramethyl-m-xylene diisocyanate (TMXDI):

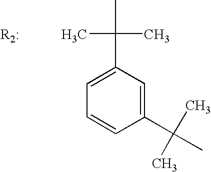

p-phenylene diisocyanate (PPDI): R²:

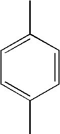

isophorone diisocyanate (IPDI),

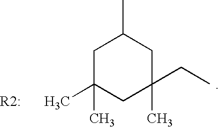

As well as p-phenylene diisocanate, it is also possible to use the corresponding o- and m-isomers. In the case of MDI, not only monomeric MDI but also polymeric MDI (PMDI) is suitable.

The aforementioned diisocyanates HDI, NDI, TDI, MDI or PMDI, TMXDI, PPDI and IPDI are particularly preferred. Accordingly, the aforementioned R² radicals are particularly preferred.

R³ is the alkylene, arylene or aralkylene radical of an aliphatic, aromatic or aromatic-aliphatic diol HO—R³—OH in the case of Y being O or of an aliphatic, aromatic or aromatic-aliphatic diamine H₂N—R³—NH₂ in the case of Y being NH.

Useful diols HO—R³—OH (Y being O) are preferably aliphatic diols, especially

Ethylene glycol, 1,4-butanediol and 1,6-hexanediol, R³: —CH₂—(CH₂)ₙ— where n=1, 2, 3, 4 or 5 (but n can also be from 6 to 10),
neopentylglycol R³:

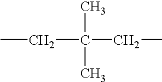

Useful diols further include for example 1,3-propanediol, 1,5-pentanediol, 1,7-heptanediol, 1,2-cyclohexanediol, 1,3-cyclohexanediol, 1,4-cyclohexanediol, 1,2-propanediol, 1,2-butanediol, 1,2-pentanediol, 1,2 hexanediol, 1,2-heptanediol, 1,2-dodecanediol, 1,2-octadecanediol, 1,8-octanediol, 2,7-dimethyl-3,5-octadiyne-2,7-diol, 2-butyl-2-ethyl-1,3-propanediol and 2-ethylhexanediol.

In contrast to WO-A 99/41320 (page 15 line 14-page 17 line 9), however, ionic diols such as dimethylolpropionic acid are unsuitable.

Useful diamines H₂N—R³—NH₂ (Y being NH) are preferably aromatic and more preferably aliphatic diamines. Useful aromatic diamines are in particular phenylenediamines.

Useful aliphatic diamines are in particular ethylenediamine and 1,6-hexamethylenediamine (R³: —CH₂—(CH₂)ₙ— where n=1 or 5).

Useful diamines further include for example 1,5-diaminonapthalene, tolylene-2,4-diamine, tolylene-2,6-diamine, methylenediphenyldiamine, tetramethyl-m-xylenediamine, o-phenylenediamine, m-phenylenediamine, p-phenylenediamine, 1,3-propanediamine, 1,4-butanediamine, 1,5-pentanediamine, 1,8-octanediamine, 4,7-dioxadecane-1,10-diamine, 4,11-dioxatetradecane-1,14-diamine, polyoxyethylenediamine, polyoxypropylenediamine, bis(3-aminopropyl)polytetrahydrofuran, polytetrahydrofurandiamine, N,N-dimethyldipropylenetriamine, ethylaminoethylamine, N,N-dimethylethylenediamine, 2-dimethylaminoethylamine, 2-diisopropylaminoethylamine, N,N-di-tert-butylethylenediamine, N,N-dimethylpropane-1,3-diamine and 3-isopropylaminopropylamine.

It is also possible to use mixtures of diols and diamines or aminoalcohols HO—R³—NH₂ to thereby form compounds I where one Y is O and one Y is NH. However, this is less preferable.

R¹ is an alkyl-capped, ie alkyl-terminated, oligoalkylene oxide radical of the general formula IV
R⁶O—(—CH₂—CH₂—O—)ₐ—(—R⁷—O—)_{b}— (IV)

In the formula, R⁶ is an alkyl radical of 1 to 4 carbon atoms, especially methyl, ethyl, n-propyl, isopropyl, n-butyl, isobutyl or sec-butyl.

R⁶ is most preferably methyl, ie the oligoalkylene oxide radical is methyl-capped.

The ethylene oxide group —(—CH₂—CH₂—O—)ₐ— is mandatorily present in the oligoalkylene oxide radical R¹, ie a is at least 1. a is customarily from 1 to 300, preferably from 1 to 200 and more preferably from 5 to 50.

R⁷ is a branched, ie nonlinear, alkyl radical of 3 to 8 carbon atoms such as for example propylene. The alkylene oxide group —(—R⁷—O—)_{b}— is optional, ie b can also be zero. That is preferred. Otherwise, b is customarily up to 15, preferably up to 3 and more preferably up to 1.

Particularly preferably, a is from 1 to 300 and b zero.

The alkylene oxide group —(—R⁷—O—)_{b}— can also be constructed of a plurality of alkylene oxides R⁷′, R⁷″, R⁷′″, etc, ie have the structure
—(R⁷′—O)_{b1}—(R⁷″—O)_{b2}—(R⁷′″—O)_{b3}—

where b1, b2 and b3 are each customarily in the range from 1 to 10 and preferably from 1 to 3.

The oligoalkylene oxide radicals of the above formula IV are derived from the corresponding oligoalkylene oxides IVa and Ivb respectively:
R⁶O—(—CH₂—CH₂—O—)ₐ—(—R⁷—O—)_{b}—OH (IVa)

when X is O

or
R⁶O—(—CH₂—CH₂—O—)ₐ—(—R⁷—O—)_{b}—NH₂ (IVb)

when X is NH.

Alkyl-capped oligoalkylene oxides having an —OH end group (above formula IVa) can be prepared in a conventional manner, for example by grafting onto an alcohol R⁶OH (eg methanol for methyl-capped oligoalkylene oxides), ethylene oxide and, when b is more than zero, higher alkylene oxides as well.

Alkyl-capped oligoalkylene oxides are also commercially available, for example as Pluriol® AnE from BASF, in which case n is generally in the range from 100 to 5000 and especially in the range from 250 to 2500. Illustrative examples are the Pluriol® grades A2000E, A1000E, A750E, A500E, A350E and A275E.

Alkyl-capped oligoalkylene oxides of the above formula IVa where b is greater than zero can for example be prepared by first converting monoalkyldiethylene glycol R⁶O—CH₂—CH₂—OH to oligoalkylene oxides of the formula R⁶O—(—CH₂—CH₂—O—)ₐ—OH in the presence of bases such as NaOH and then reacting these oligoalkylene oxides with alkylene oxides R⁷O such as propylene oxide (R⁷=propylene) to form the oligoalkylene oxide IVa R⁶O—(—CH₂—CH₂—O—)ₐ—(—R⁷—O—)_{b}—OH.

The above alkyl-capped oligoalkylene oxides featuring OH termination can be subjected to catalytic reductive amination to prepare alkyl-capped oligoalkylene oxides IVb featuring NH₂ termination
R⁶O—(CH₂—CH₂—O)ₐ—(R⁷—O)_{b}—NH₂ (IVb)

More particularly, such aminated alkyl-capped oligoalkylene oxides can for example be prepared by direct reaction of the corresponding alcohol (—OH end group) with ammonia. This amination is customarily carried out over a heterogeneous catalyst, especially over catalysts containing oxygen-containing compounds of zirconium, of copper, of cobalt and of nickel (ZrO₂/CuO/CoO/NiO catalyst). The reaction is for example described in EP-A 382 049, expressly incorporated herein by reference.

The starting materials mentioned are used in a preferred embodiment to prepare the compounds I by reacting a diisocyanate OCN—R²—NCO with a diol HO—R³—OH, when Y is O or with a diamine H₂N—R³—NH₂, when Y is NH and with an alkyl-capped oligoalkylene oxide of the general formula IVa when X is O,
R⁶O—(—CH₂—CH₂—O—)ₐ—(—R⁷—O—)_{b}—OH (IVa)

or of the general formula IVb when X is NH,
R⁶O—(—CH₂—CH₂—O—)ₐ—(—R⁷—O—)_{b}—NH₂ (IVb).

The proportions in which the starting materials are used depend as usual on the desired reaction product (compound I) and are generally based on the molar amount of the diisocyanate used, as is customary in the isocyanate art. For example, r mol of diol or diamine can be used per (r+1) mol of diisocyanate, and so on.

The diisocyanate can be reacted first with the diol or diamine and then with the oligoalkylene oxide. Similarly, the diisocyanate can be first reacted with the oligoalkylene oxide and then with the diol or diamine. However, both the diol/diamine and the oligoalkylene oxide can be added to the diisocyanate and simultaneously reacted with the diisocyanate. The order is accordingly freely choosable.

The reaction of the diisocyanates with the diols or diamines is carried out in a conventional manner, for example by using catalysts. Useful catalysts include for example tertiary amines, eg triethylamine, dimethylcyclohexylamine, N-methylmorpholine, N,N-dimethylpiperazine, 2-(dimethylaminoethoxy)ethanol, diazabicyclo(2,2,2)octane and the like, and also in particular organic metal compounds such as titanate esters, iron compounds, eg iron(III) acetylacetonates, tin compounds, eg tin diacetate, tin dioctoate, tin dilaurate or the dialkyl derivatives of tin dialkyl salts of aliphatic carboxylic acids such as dibutyltin diacetate, dibutyltin dilaurate or the like. The catalysts are customarily used in amounts from 0.0001 to 0.1 part by weight per 100 parts by weight of diol or diamine.

The reaction is customarily carried out in an aprotic solvent, for example in tetrahydrofuran, diethyl ether, diisopropyl ether, chloroform, dichlormethane, di-n-butyl ether, acetone, N-methylpyrrolidone (NMP), xylene, toluene, methyl ethyl ketone (MEK), methyl isobutyl ketone (MIBK), N,N-dimethylformamide (DMF) or 1,4-dioxane. However, protic solvents such as water or alcohols are suitable as well.

Preferred reaction temperatures range from −80° C. to the boiling point of the solvent used. The reaction is generally carried out under atmospheric pressure, but reactions in autoclaves at up to 20 bar are suitable as well.

The number r can range from 0 to 100. When r is greater than zero, oligomeric or polymeric compounds I having an ABA block structure are obtained. The number r of repeat units is not more than 100 and customarily up to 20.

When r is zero—and these compounds I are preferred—the low molecular weight or monomeric compounds I obtained have pronounced surface-active properties and will hereinafter be referred to as surfactants for short. The surfactants are preferably prepared in accordance with the above directions, although no diol HO—R³—OH or diamine H₂N—R³—NH₂ is used on account of r being zero. That is, the diisocyanate OCN—R²—NCO is reacted with the alkyl-capped oligoalkylene oxide IVa or IVb to form the surfactant I (where r is 0).

r is preferably 0, ie the surfactant compounds I preferably have the formula Ia
R¹—X—CO—NH—R²—NH—CO—X—R¹ (Ia)

When R² is 1,5-naphthylene (derived from naphthylene 1,5-diisocyanate), the product formed is thus a surfactant of the formula Ib:

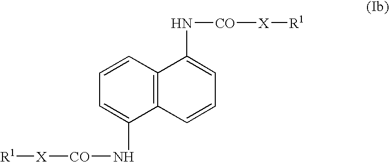

Particular preference is given to compounds I where R⁶ is methyl and r is 0, ie to ABA surfactants having methyl-capped oligoalkylene oxide radicals R¹.

The compounds of the general formula II
R¹—X—[—CO—NH—R²—NH—CO—Y—R³—Y—]ᵣ—CO—NH—R⁴ (II)

have an AB block structure in which the alkyl-capped oligoalkylene oxide radical R¹ constitutes the A block and the structure —X—[—CONH—R²—NHCO—Y—R³—Y—]ᵣ—CONH—R⁴ constitutes the B block:
R¹—X—[CONH—R²—NHCO—Y—R³—Y—]ᵣ—CONH—R⁴A|B

The explanations given above in relation to the compounds I with regard to the variables X, Y, R¹, R², R³, R⁶, R⁷, r, a and b, with regard to the starting materials and with regard to the method of making apply mutatis mutandis to the compounds II as well, except when otherwise specified.

Compound II differs from compound I in having an —R⁴ group in the formula II instead of the —R²—NH—CO—X—R¹ group in the formula I.

R⁴ is the alkyl, aryl or aralkyl radical of an aliphatic, aromatic or aromatic-aliphatic monoisocyanate R⁴—NCO.

Useful monoisocyanates R⁴—NCO include for example: methyl isocyanate, ethyl isocyanate, propyl isocyanate, n-butyl isocyanate, tert-butyl isocyanate, isobutyl isocyanate, pentyl isocyanate, neopentyl isocyanate, 2-ethylhexyl isocyanate, phenyl isocyanate, tolyl isocyanate, 1-napthyl isocyanate and 2-napthyl isocyanate and also thioisocyanates such as methyl thioisocyanate, ethyl thioisocyanate, propyl thioisocyanate, n-butyl thioisocyanate, tert-butyl thioisocyanate, isobutyl thioisocyanate, pentyl thioisocyanate, neopentyl thioisocyanate, 2-ethylhexyl thioisocyanate, phenyl thioisocyanate, tolyl thioisocyanate, 1-napthyl thioisocyanate and 2-napthyl thioisocyanate.

1-Naphthyl isocyanate and 2-naphthyl isocyanate are particularly preferred.

The starting materials mentioned are used in a preferred embodiment to prepare the compounds II by reacting a diisocyanate OCN—R²—NCO with a diol HO—R³—OH, when Y is O or with a diamine H₂N—R³—NH₂, when Y is NH and with an alkyl-capped oligoalkylene oxide of the general formula IVa when X is O,
R⁶O—(—CH₂—CH₂—O—)ₐ—(—R⁷—O—)_{b}—OH (IVa)

or of the general formula IVb when X is NH,
R⁶O—(—CH₂—CH₂—O—)ₐ—(—R⁷—O—)_{b}—NH₂ (IVb)

and also with a monoisocyanate R⁴—NCO.

The aforementioned process for preparing the compounds II consequently differs from the above-described process for preparing the compounds I by additionally including a reaction with a monofunctional compound R⁴—NCO.

The proportions of the materials used as starting materials depend as usual on the desired reaction product (compound II) and are generally based on the molar amount of the diisocyanate used, as is customary in the isocyanate art. For example, r mol of diol or diamine can be used per r mol of diisocyanate, etc.

The order of the reactions to prepare the compound II is freely choosable. For instance, the diisocyanate can be reacted first with the diol or diamine and then with the oligoalkylene oxide and the monoisocyanate. It is similarly possible to react the diisocyanate first with the diol or diamine and with the monoisocyanate before adding the oligoalkylene oxide. It is likewise possible to add the oligoalkylene oxide and the diol or diamine to a mixture of diisocyanate and monoisocyanate.

The integer r can be from 0 to 100. When r is greater than zero, oligomeric or polymeric compounds II having an AB block structure are obtained. r is not more than 100 and customarily up to 20.

When r is zero—and these compounds II are preferred—the low molecular weight or monomeric compounds II obtained have surface-active properties (surfactants). The surfactants are preferably prepared as described above, although no diol HO—R³—OH or diamine H₂N—R³—NH₂ nor any diisocyanate OCN—R²—NCO is used on account of r being 0. That is, the alkyl-capped oligoalkylene oxide IVa or IVb is reacted with the monoisocyanate R⁴—NCO to form the surfactant II (where r is 0).

r is preferably 0, ie the surfactant compounds II preferably have the formula IIa
R¹—X—CO—NH—R⁴ (IIa)

When R⁴ is naphthyl (derived from naphthyl isocyanate), the product obtained is thus a surfactant of the formula IIb:

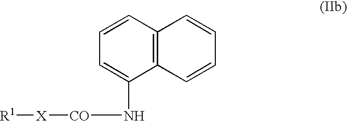

Particular preference is given to compounds II where R⁶ is methyl and r is 0, ie to AB surfactants having methyl-capped oligoalkylene oxide radicals R¹.

The compounds of the general formula III
R¹—X—[—CO—NH—R²—NH—CO—Y—R³—Y—]ᵣ—CO—NH—R²—NH—CO—Z—R⁵ (III)
have an AB block structure in which the alkyl-capped oligoalkylene oxide radical R¹ constitutes the A block and the structure —X—[—CONH—R²—NHCO—Y—R³—Y—]ᵣ—CONH—R²—NHCO—Z—R⁵ constitutes the B block:
R¹—X—[CONH—R²—NHCO—Y—R³—Y—]ᵣ—CONH—R²—NHCO—Z—R⁵A|B

The explanations given above in relation to the compounds I with regard to the variables X, Y, R¹, R², R³, R⁶, R⁷, r, a and b, with regard to the starting materials and with regard to the method of making apply mutatis mutandis to the compounds III as well, except when otherwise specified.

Z can be O or NH.

Compound III differs from the compounds I and II by having an —R²—NH—CO—Z—R⁵ group in the formula III instead of respectively the —R²—NH—CO—X—R¹ group in the formula I and the R⁴ group in the formula II.

R⁵ is the alkyl, aryl or aralkyl radical of an aliphatic, aromatic or aromatic-aliphatic monoalcohol R⁵—OH when Z is O or respectively an aliphatic, aromatic or aromatic-aliphatic monoamine R⁵—NH₂ when Z is NH.

Useful monoalcohols R⁵—OH include for example: methanol, ethanol, n-propanol, i-propanol, n-butanol, sec-butanol, tert-butanol, pentanol, hexanol, heptanol, dodecanol, octadecanol, benzyl alcohol, less preference being given to phenols: phenol, α-napthol, β-napthol, cyclohexanol, tert-amyl alcohol, propargyl alcohol, butyn-3-ol, 3-Methyl-3-buten-1-ol, 3-methyl-2-buten-1-ol, 2-methyl-3-buten-2-ol, 2-methyl-3-butyn-2-ol, ethynyl-1-cyclohexanol, ethyloctynol, 1-methoxy-2-propanol, 4-methylbenzyl alcohol, 4-tert-butylbenzyl alcohol, 2-(4-methoxyphenyl)ethanol, neopentyl alcohol, 1-butoxy-2-propanol, 1-methoxy-2-butanol, 3-methyl-3-pentanol, 6-chloro-1-hexanol, 8-chloro-1-octanol, 2-methylcyclohexanol and 3-methyl-1-pentyn-3-ol.

Useful monoamines R⁵—NH₂ include for example:
primary aliphatic amines such as methylamine, ethylamine, n-propylamine, isopropylamine, n-butylamine, isobutylamine, sec-butylamine, amylamine, n-pentylamine, isopentylamine, neopentylamine, 3-methyl-2-butylamine, hexylamine, octylamine, dodecylamine, tridecylamine, octadecylamine, mono-2-ethylhexyl-amine, 6-methyl-2-heptanamine, cyclopropylamine and cyclopentylamine;
secondary aliphatic amines such as dimethylamine, diethylamine, di-n-propylamine, diisopropylamine, dibutylamine, diisobutyl-amine, di-sec-butylamine, dipentylamine, diisopentylamine, dihexylamine, di-2-ethylhexylamine, ditridecylamine, N-ethyl-isopropylamine, 1-methoxy-2-aminopropane, N-ethyl-1,2-dimethyl-propylamine, n-methylbenzylamine, tert-butylbenzylamine, 4-methoxybenzylamine, phenylethylamine, 1-methyl-3-phenyl-propylamine, N-methylaniline, 2,6-xylidine and 3,5-xylidine;
primary aromatic amines such as aniline, 1-chloroaniline, 2-chloroaniline, 3-chloroaniline, 2,3-dichloroaniline, 3,4-dichloroaniline, 3,5-dichloroaniline, 2,5-dichloroaniline, 2,6-dichloroaniline, the corresponding bromoanilines, 1-naphthylamine, 2-naphthylamine, substituted naphthylamines, 2,6-diisopropylaniline, benzylamine, o,m,p-toluidine and the class of the alkoxyanilines (especially methoxyanilines) and of the nitroanilines;
finally ammonia, N-ethylbutylamine, β-hydroxyethylamine, β- or γ-hydroxypropylamine, N-methylethanolamine, diethanolamine, 3-(2-hydroxyethylamino)-1-propanol, ethanolamine, diethanolamine, N-(2-hydroxyethyl)aniline, hydroxylamine, hydrazine, 3-ethoxypropylamine, di-(2-methoxyethyl)amine, cyclohexylamine, N-ethylcyclohexylamine, dicyclohexylamine, 2-phenylethylamine, 4-methoxyphenylethylamine, 1-phenyl-3-phenylpropylamine, 2-(3,4-dimethoxyphenyl)ethylamine, N-ethylaniline, 2-(2-aminoethoxy)ethanol and 2-(2-(3-aminopropoxy)ethoxy)ethanol.

The starting materials mentioned are used in a preferred embodiment to prepare the compounds III by reacting a diisocyanate OCN—R²—NCO with a diol HO—R³—OH when Y is O or with a diamine H₂N—R³—NH₂ when Y is NH and with an alkyl-capped oligoalkylene oxide of the general formula IVa when X is O,
R⁶O—(CH₂—CH₂—O)ₐ—(R⁷—O)_{b}—OH (IVa)

or of the general formula IVb when X is NH,
R⁶O—(CH₂—CH₂—O)ₐ—(R⁷—O)_{b}—NH₂ (IVb)

and also, when Z is O, with the monoalcohol R⁵—OH or, when Z is NH, with the monoamine R⁵—NH₂.

The abovementioned process for preparing the compounds III consequently differs from the above-described process for preparing the compounds I in that it additionally comprises a reaction with a monofunctional compound R⁵—OH or R⁵—NH₂. It differs from the process for preparing the compounds II in that the monofunctional compound it utilizes is R⁵—OH or R⁵—NH₂ (instead of R⁴—NCO).

The proportions in which the materials used as starting materials are used depend as usual on the desired reaction product (compound III) and are generally based on the molar amount of diisocyanate used, as is customary in the isocyanate art. For example, r mol of diol or diamine can be used per (r+1) mol of diisocyanate, etc.

The order of the reactions to prepare the compound III is freely choosable. For instance, the diisocyanate can be reacted first with the diol or diamine and then with the oligoalkylene oxide and the monoamine or monoalcohol. It is similarly possible first to react the diisocyanate with the diol or diamine and the monoamine or monoalcohol before adding the oligoalkylene oxide. It is likewise possible to add the oligoalkylene oxide to a mixture of diol and monoalcohol or diamine and monoamine.

The integer r can be from 0 to 100. When r is greater than zero, oligomeric or polymeric compounds III having an AB block structure are obtained. r is not more than 100 and customarily up to 20.

When r is zero—and these compounds III are preferred—the low molecular weight or monomeric ompounds III obtained have surface-active properties (surfactants). The surfactants are preferably prepared as described above, although no diol HO—R³—OH or diamine H₂N—R³—NH₂ nor a diisocyanate OCN—R²—NCO is used on account of r being 0. That is, the alkyl-capped oligoalkylene oxide IVa or IVb is reacted with the monoalcohol R⁵—OH or monoamine R⁵—NH₂ to form the surfactant III (where r is 0).

r is preferably 0, ie the surfactant compounds III preferably have the formula IIIa
R¹—X—CO—NH—R²—NH—CO—Z—R⁵ (IIIa)

Particular preference is given to compounds III where R⁶ is methyl and r is 0, ie to AB surfactants having methyl-capped oligoalkylene oxide radicals R¹.

r in the compounds I, II and III is a positive rational number since the process of making the compounds may give rise to distributions which are not described by integral r.

According to the invention, the compounds I, II and III can be used as dispersants for pigments.

The present invention likewise provides for the use of the compounds I, II and III as process chemicals (assistants, auxiliaries) in pigment manufacture.

Pigments are defined in the German standards DIN 55943 (September 1984), DIN 55944 and DIN 55945 (August 1983) as inorganic or organic, chromatic or achromatic colorants which are virtually insoluble in the application medium. Pigments will hereinbelow be named in accordance with Colour Index (C.I.) nomenclature, although the “C.I.” constituent may be omitted in some instances.

There now follow examples of useful pigments, vat dyes being, for the purposes of this invention, considered as organic pigments.

Organic pigments:

| | |
|---|---|
| monoazo pigments: | C.I. Pigment Brown 25; C.I. Pigment |
| | Orange 5, 13, 36 and 67; C.I. |
| | Pigment Red 1, 2, 3, 5, 8, 9, 12, |
| | 17, 22, 23, 31, 48:1, 48:2, 48:3, |
| | 48:4, 49, 49:1, 52:1, 52:2, 53, |
| | 53:1, 53:3, 57:1, 63, 112, 146, 170, |
| | 184, 190, 210, 245 and 251; C.I. |
| | Pigment Yellow 1, 3, 73, 74, 65, 97, |
| | 151 and 183; |
| disazo pigments: | C.I. Pigment Orange 16, 34 and 44; |
| | C.I. Pigment Red 144, 166, 214 and |
| | 242; C.I. Pigment Yellow 12, 13, 14, |
| | 16, 17, 81, 83, 106, 113, 126, 127, |
| | 155, 174, 176 and 188; |
| anthanthrone pigments: | C.I. Pigment Red 168 (C.I. Vat |
| | Orange 3); |
| anthraquinone pigments: | C.I. Pigment Yellow 147 and 177; |
| | C.I. Pigment Violet 31; |
| anthrapyrimidine pigments: | C.I. Pigment Yellow 108 (C.I. Vat |
| | Yellow 20); |
| quinacridone pigments: | C.I. Pigment Red 122, 202 and 206; |
| | C.I. Pigment Violet 19; |
| quinophthalone pigments: | C.I. Pigment Yellow 138; |
| dioxazine pigments: | C.I. Pigment Violet 23 and 37; |
| flavanthrone pigments: | C.I. Pigment Yellow 24 (C.I. Vat |
| | Yellow 1); |
| indanthrone pigments: | C.I. Pigment Blue 60 (C.I. Vat Blue |
| | 4) and 64 (C.I. Vat Blue 6); |
| isoindoline pigments: | C.I. Pigment Orange 69; C.I. Pigment |
| | Red 260; C.I. Pigment Yellow 139 and |
| | 185; |
| isoindolinone pigments: | C.I. Pigment Orange 61; C.I. Pigment |
| | Red 257 and 260; C.I. Pigment Yellow |
| | 109, 110, 173 and 185; |
| isoviolanthrone pigments: | C.I. Pigment Violet 31 (C.I. Vat |
| | Violet 1); |
| metal complex pigments: | C.I. Pigment Yellow 117, 150, 153 |
| | and 177; C.I. Pigment Green 8; |
| perinone pigments: | C.I. Pigment Orange 43 (C.I. Vat |
| | Orange 7); C.I. Pigment Red 194 |
| | (C.I. Vat Red 15); |
| perylene pigments: | C.I. Pigment Black 31 and 32; C.I. |
| | Pigment Red 123, 149, 178, 179 (C.I. |
| | Vat Red 23), 190 (C.I. Vat Red 29) |
| | and 224; C.I. Pigment Violet 29; |
| phthalocyanine pigments: | C.I. Pigment Blue 15, 15:1, 15:2, |
| | 15:3, 15:4, 15:6 and 16; C.I. |
| | Pigment Green 7 and 36; |
| pyranthrone pigments: | C.I. Pigment Orange 51; C.I. Pigment |
| | Red 216 (C.I. Vat Orange 4); |
| thioindigo pigments: | C.I. Pigment Red 88 and 181 (C.I. |
| | Vat Red 1); C.I. Pigment Violet 38 |
| | (C.I. Vat Violet 3); |
| triarylcarbonium pigments: | C.I. Pigment Blue 1, 61 and 62; C.I. |
| | Pigment Green 1; C.I. Pigment Red |
| | 81, 81:1 and 169; C.I. Pigment |

vat dyes (in addition to those already mentioned above):
C.I. Vat Yellow 2, 3, 4, 5, 9, 10, 12, 22, 26, 33, 37, 46, 48, 49 and 50;
C.I. Vat Orange 1, 2, 5, 9, 11, 13, 15, 19, 26, 29, 30 and 31;
C.I. Vat Red 2, 10, 12, 13, 14, 16, 19, 21, 31, 32, 37, 41, 51, 52 and 61;
C.I. Vat Violet 2, 9, 13, 14, 15, 17 and 21;
C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 35 64, 65, 66, 72 and 74;
C.I. Vat Green 1, 2, 3, 5, 7, 8, 9, 13, 14, 17, 26, 29, 30, 31, 32, 33, 40, 42, 43, 44 and 49;
C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 40 83 and 84;

C.I. Vat Black 1, 2, 7, 8, 9, 13, 14, 16, 19, 20, 22, 25, 27, 28, 29, 30, 31, 32, 34, 36, 56, 57, 58, 63, 64 and 65;

inorganic pigments:

| | |
|---|---|
| white pigments: | titanium dioxide (C.I. Pigment White |
| | 6), zinc white, pigment grade zinc |
| | oxide; zinc sulfide, lithopone; lead |
| | white; |
| black pigments: | iron oxide black (C.I. Pigment Black |
| | 11), iron manganese black, spinel |
| | black (C.I. Pigment Black 27); |
| | carbon black (C.I. Pigment Black 7); |
| chromatic pigments: | chromium oxide, chromium oxide |
| | hydrate green; chrome green (C.I. |
| | Pigment Green 48); cobalt green |
| | (C.I. Pigment Green 50); ultramarine |
| | green; cobalt blue (C.I. Pigment |
| | Blue 28 and 36); ultramarine blue; |
| | iron blue (C.I. Pigment Blue 27); |
| | manganese blue; ultramarine violet; |
| | cobalt violet and manganese violet; |
| | iron oxide red (C.I. Pigment Red |
| | 101); cadmium sulfoselenide (C.I. |
| | Pigment Red 108); molybdate red |
| | (C.I. Pigment Red 104); ultramarine |
| | red; |
| | iron oxide brown, mixed brown, |
| | spinel and corundum phases (C.I. |
| | Pigment Brown 24, 29 and 31), chrome |
| | orange; |
| | iron oxide yellow (C.I. Pigment |
| | Yellow 42); nickel titanium yellow |
| | (C.I. Pigment Yellow 53; C.I. |
| | Pigment Yellow 157 and 164); chrome |
| | titanium yellow; cadmium sulfide and |
| | cadmium zinc sulfide (C.I. Pigment |
| | Yellow 37 and 35); chrome yellow |
| | (C.I. Pigment Yellow 34), zinc |
| | yellow, alkaline earth metal |
| | chromates; Naples yellow; bismuth |
| | vanadate (C.I. Pigment Yellow 184); |
| interference pigments: | metallic effect pigments based on |
| | coated metal platelets; pearl luster |
| | pigments based on mica platelets |
| | coated with metal oxide; liquid |
| | crystal pigments. |

Preferred pigments in this context are: perylene pigments, phthalocyanine pigments, indanthrone pigments, isoindoline pigments, quinacridone pigments, interference pigments. Of these, perylene pigments, isoindoline pigments and indanthrone pigments are particularly preferred.

Examples of particularly preferred pigments are specifically: Pigment Blue 15:1 and 60, Pigment Red 179, Pigment Yellow 139 and Pigment Green 7.

Further suitable pigments are mentioned in W. Herbst et al., Industrial organic Pigments, VCH Weinheim, 1993.

The present invention further provides pigment preparations which include at least one of the compounds of the general formulae I to III and at least one inorganic or organic pigment. Preferably the pigment preparations further include water. However, water is not a mandatory ingredient.

The pigment preparations may include organic solvents in lieu of or in addition to water. Useful organic solvents include for example glycols and glycol ethers such as n-butylglycol and ethylene glycol and also higher ethylene glycols HO—(—CH₂—CH₂—)ₙ—OH where is an integer from 2 to 50.

The pigment preparations according to the present invention may further include customary polymeric binders.

In a particularly preferred embodiment, the pigment preparations of the present invention include

a) from 0.001 to 97%, preferably from 0.1 to 20% and more preferably from 1 to 15% by weight of at least one of the compounds I, II and/or III according to the present invention, the aforementioned amounts being based on the sum total of the compounds I, II and III,

b) from 1 to 97%, preferably from 2 to 50% and more preferably from 5 to 30% by weight of at least one pigment,

c) from 1 to 80%, preferably from 10 to 50% and more preferably from 12 to 45% by weight of at least one polymeric binder, and

d) from 1 to 97%, preferably from 5 to 90% and more preferably from 15 to 82% by weight of water.

For any one pigment preparation, the percentage fractions add up to 100% by weight.

When the pigment preparations include organic solvents, the organic solvents fraction is generally in the range from 1 to 97%, preferably in the range from 1 to 30% and more preferably in the range from 1 to 10% by weight.

All the aforementioned amounts are based on the pigment preparations.

The preparations may include further customary paints and coatings additives, for example preservatives, antioxidants, degassers, defoamers, viscosity regulators, thickeners, flow control agents, wetters or surfactants, anti-setters, gloss improvers, glidants, adhesion improvers, skin formation inhibitors, delusterants, emulsifiers, stabilizers, hydrophobicizers, light control additives, hand improvers, antistats, acids, bases and buffers for regulating the pH, dispersants other than the compounds according to the present invention and further assistants and auxiliaries familiar to those skilled in the art.

According to the present invention, the pigment preparations can be used in water-containing coatings, printing inks and paints. Water is one ingredient of these coatings, printing inks and paints, but not necessarily the main constituent of the liquid phase.

In waterborne coatings, by contrast, water is a main constituent and generally comprises at least 50% and preferably at least 70% by weight of the coating. According to the present invention, the aforementioned pigment preparations are particularly useful in waterborne coatings. To this end, the pigment preparations are formulated for example as waterborne coating pastes, which customarily include at least 20% and preferably at least 30% by weight of water.

The aforementioned water-containing coatings, water-containing printing inks and paints and also the waterborne coatings likewise form part of the subject matter of the present invention.

The compounds I, II and III according to the present invention, when used as pigment dispersants, improve the color properties, especially color strength, chroma and transparency. They similarly improve the Theological properties such as yield point and viscosity of the pigment preparations. They improve in particular the dispersibility (dispersion harshness) of the pigments. The compounds I, II and III according to the present invention can also be used to produce pigment preparations which develop their final color values simply on stirring in a dissolver, without assistance of a stirred media mill.

Even relatively high concentrations of the compounds I, II and III in the pigment preparations generally do not cause the preparations to become gooey or doughy. They reduce the undesirable recrystallization of pigments and prevent disadvantageous particle growth. They also make it possible to produce high-pigment pigment preparations.

The compounds I, II and III further facilitate the manufacture of pigments and thus are very useful as process chemicals in the pigment manufacturing operation. A pigment manufacturing operation comprises in particular:
a pigment synthesis, including crystallization and subsequent drying;
a wet treatment and subsequent drying step. Here, wet treatment comprehends for example wet ball milling, kneading with and without salt or simply stirring of an aqueous suspension, and drying step comprehends the use of for example a drying cabinet, a belt dryer, a paddle dryer, a freeze dryer, a spray dryer, a shaft dryer, a tumble dryer, a fluidized bed dryer, a pneumatic conveying dryer or a spin flash dryer;
dry milling with steel balls.

A number of individual compounds conforming to the formulae I, II and III also improve the condensation resistance of automotive paintwork owing to their lower solubility and reduced tendency to migrate, compared with prior art dispersants. Finally, some of the compounds I and II reduce the undesirable blistering during the baking of paint films.

The examples which follow illustrate the invention.

### EXAMPLES

### 1. Preparation of Alkyl-capped Oligoalkylene Oxides

a) Oligoalkylene oxides MeOCH₂—CH₂—O)ₐ—OH

The following Pluriol® products from BASF were used. The number of ethylene oxide units (index a) conforms to a distribution. In each case, the main constituent of the product is reported. Me is methyl.

Pluriol A20000E: MeOCH₂—CH₂—O)₄₅—OH

Pluriol A1000E: MeOCH₂—CH₂—O)₂₅—OH

Pluriol A500E: MeOCH₂—CH₂—O)₁₁—OH

Pluriol A350E: MeOCH₂—CH₂—O)₈—OH

Pluriol A275E: MeOCH₂—CH₂—O)₆—OH

b) Oligoalkylene Oxides MeOCH₂—CH₂—O)ₐ—NH₂

b1) Preparation of MeOCH₂—CH₂—O)₁₁—NH₂

A 2.5 l autoclave equipped with a mechanical stirrer was charged with 800 g of Pluriol A500E and 200 ml of a ZrO₂/CuO/CoO/NiO catalyst. The catalyst had previously been prepared as described in EP-B 382 049 at page 6 lines 1-16 (“catalyst A”). 400 ml of ammonia were injected at 23° C.; thereafter, hydrogen was injected to a pressure of 50 bar. After heating to 175° C., more hydrogen was injected, to a pressure of 200 bar. After 24 hours at 175° C. and 200 bar the autoclave was cooled down and depressurized and the contents were filtered to remove the catalyst. Excess ammonia and the water of reaction were removed in a rotary evaporator. The degree of conversion was determined with reference to the amine number, which was determined by titration in glacial acetic acid against 0.1 N perchloric acid. The amine number was found to be 597 eq.

b2) Preparation of MeOCH₂—CH₂—O)₆—NH₂

The procedure of b1) was repeated using 400 g of Pluriol A275E. The amine number, determined as in the case of b1), was found to be 296 eq.

### 2. Preparation of Compounds I, II and III

All the reactions were carried out with absolute tetrahydrofuran (THF) and under dried nitrogen gas, and with stirring. The isocyanate content was determined by reacting a sample of the reaction mixture with a 2% by weight solution of dibutylamine in xylene before a potentiometric titration against 0.1 N hydrochloric acid.

a) Compounds I

### Example H1

polymeric compound I where R¹=MeOCH₂—CH₂—O)₄₅ (R⁶=Me), R²=1,5-naphthylene, R³=ethylene, X=O, Y=NH

6.3 g of naphthylene 1,5-diisocyanate (NDI) were dissolved in 200 ml of THF by heating. A solution of 0.9 g of ethylenediamine in 50 ml of THF was added dropwise at 23° C. over 30 min. The white suspension obtained was refluxed for 1 hour. Thereafter, a solution of 60 g of Pluriol A2000E in 100 ml of THF was added over 30 min. This was followed by a further hour of refluxing. To destroy any trace isocyanate present, a few drops of ammonia solution were added. The THF was distilled off under reduced pressure. This provided 681 g of a polymer having a melting point of 270° C.

### Example H2

polymeric compound I where R¹=MeOCH₂—CH₂—O)₂₅ (R⁶=Me), R²=tetramethyl-m-xylolene, R³=neopentylene, X=O, Y=O

524.78 g of neopentylglycol and 1 475.22 g of tetramethyl-m-xylene diisocyanate (TMXDI) were dissolved in 2000 g of THF at 25° C., admixed with 0.52 g of dibutyltin dilaurate and then maintained at 60° C. until the isocyanate content had decreased to 2.1%. Thereafter, a solution of 2146 g of Pluriol A1000E in 2146 g of THF was added over 1 min. After addition of a further 2.2 g of dibutyltin dilaurate, the reaction mixture was maintained at 60° C. until the isocyanate content had decreased to 0%. 5200 g of water were added and the THF was distilled off under reduced pressure. The product obtained was filtered to remove water. This left 4250 g of a viscous polymeric oil.

### Example H3

polymeric compound I where R¹=MeOCH₂—CH₂—O)₁₁ (R⁶=Me), R²=1,5-naphthylene, R³=ethylene, X=NH, Y=NH

31.5 g of naphthylene 1,5-diisocyanate were dissolved in 350 ml of THF by heating. A solution of 6 g of ethylenediamine in 50 ml of THF was added at 23° C. with cooling over 30 min. The white suspension obtained was maintained at 23° C. for 30 min. Thereafter, a solution of 50 g of MeO+CH₂—CH₂—O)₁,—NH₂ (see above under 1.b1)) in 100 ml of THF was added over 30 min. The reaction mixture was maintained at 23° C. for a further 30 min. To destroy any trace isocyanate, a few drops of ammonia solution were added. The THF was distilled off under reduced pressure. This provided 89 g of a polymer having a melting point of 255° C.

### Example H4

surfactant compound I where R¹32 MeOCH₂—CH₂—O)₈ (R⁶=Me), R²=1,5-naphthylene, no R³ and r=0, X=O, Y missing since r=0

10.5 g of naphthylene 1,5-diisocyanate were dissolved in 200 ml of THF by heating. A solution of 35 g of Pluriol A350E in 100 ml of THF was added at 23° C. over 30 min. Any trace isocyanate was destroyed with a few drops of ammonia solution. The THF was distilled off under reduced pressure to leave 46 g of a pasty surfactant.

### Example H5

surfactant compound I where R¹=MeOCH₂—CH₂—O)₆ (R⁶=Me), R²=1,5-naphthylene, no R³ and r=0, X=NH, Y missing since r=0

20 g of naphthylene 1,5-diisocyanate were dissolved in 100 ml of THF by heating. A solution of 67 g of MeOCH₂—CH₂—O)₆—NH₂ (see above under 1.b2) in 200 ml of THF was added at 23° C. over 30 min. The white suspension obtained was diluted with 500 ml of THF and maintained at 23° C. for a further hour. Any trace isocyanate was destroyed with a few drops of ammonia solution. The THF was distilled off under reduced pressure to leave 88 g of a pasty surfactant.

b) Compounds II and III

### Example H6

polymeric compound III where R¹=MeOCH₂—CH₂—O)₂₅ (R⁶=Me), R²=1,5-naphthylene, R³=ethylene, R⁵=tert-butyl, X=O, Y=NH, Z=NH

47.3 g of naphthylene 1,5-diisocyanate in 500 ml of THF were briefly heated to the boil under reflux to obtain a homogeneous solution. A solution of 25 g of Pluriol A1000E in 50 ml of THF was added at 23° C. over 30 min. The clear solution obtained was held at 23° C. for a further 30 min. Thereafter, a solution of 12 g of ethylenediamine and 50 ml of THF was added at 0° C. over 30 min. The white suspension obtained was maintained at 23° C. for a further 2 hours. Thereafter, a solution of 1.9 g of tert-butylamine in 50 ml of THF was added at 23° C. over 1 min before the batch was subsequently maintained at 23° C. for a further 30 min. Any trace isocyanate was destroyed with a few drops of ammonia solution. The THF was distilled off under reduced pressure to leave 87 g of a polymer having a melting point of 266° C.

### Example H7

surfactant compound II where R¹=MeOCH₂—CH₂—O)₁₂ (R⁶=Me), no R², no R³ and r=0, R⁴=naphthyl, X=O, Y missing since r=0

14.8 g of Pluriol A500E were dissolved in 100 ml of THF. A solution of 5.0 g of 1-naphthyl isocyanate (monoisocyanate) in 50 ml of THF was added at 23° C. over 30 min. The clear solution was subsequently maintained at 65° C. for 2 hours. Any trace isocyanate was destroyed with a few drops of ammonia solution. The THF was distilled off under reduced pressure to leave 27.1 g of a slightly brownish, viscid, clear surfactant.

### Example H8

surfactant compound II where R¹=MeOCH₂—CH₂—O)₆ (R⁶=Me), no R², no R³ and r=0, R⁴=naphthyl, X=NH, Y missing since r=0

15.1 g of MeO—(—CH₂—CH₂—O—)₆—NH₂ (see above under 1.b2)) were dissolved in 100 ml of THF. A solution of 7.0 g of 1-naphthyl isocyanate (monoisocyanate) in 50 ml of THF was added at 23° C. over 30 min. The clear solution was subsequently maintained at 65° C. for 2 hours. Any trace isocyanate was destroyed with a few drops of ammonia solution. The THF was distilled off under reduced pressure to leave 21 g of a yellow pasty surfactant.

3. Use of compounds I, II and III

The average primary particle sizes were determined from transmission electron micrographs.

a) General prescription for preparing the aqueous coating system in a waterborne coating test system

Coating pastes were produced by using the pigment and one of the compounds H1 to H8 to produce pigment preparations (see examples A1 to A8 hereinbelow). 15 g of each of these pigment preparations were dispersed in 85 g of an aqueous coating system (aqueous anionically stabilized polyurethane dispersion) on a Skandex shaker from Lau for 2 hours. The coating system (polyurethane dispersion) consisted of 23.5 g of polyurethane polymer, 60 g of water and 1.5 g of a 10% by weight solution of N,N-dimethylaminoethanol in water. The dispersing was effected in a 250 ml glass bottle using 231 g of SAZ balls 1 mm in diameter.

The waterborne coating paste was white reduced in a ratio of 1:5 with a TiO₂ dispersion (“white testing binder”, consisting essentially of 40% by weight of TiO₂, 20% by weight of anionically stabilized polyurethane dispersion and 40% by weight of water) to produce white reductions. On the basis of these white reductions the dispersibility (dispersion harshness) was visually examined under daylight (CIE D65) from an inspection lamp conforming to ASTM D1729 after a dispersing time of 12 minutes and after a dispersing time of 120 minutes.

The visual assessments were made in accordance with the table below.

TABLE
visual assessment of colorations

| | Difference in hue | | |
|---|---|---|---|
| | angle dH*, | | |
| | chroma dC*, | Coloring | |
| Rating | lightness dL* | equivalents | was assessed as |
| 1 | 0-0.15 | 98-102 | “equal” |
| | | (basis) | |
| 2 | >0.15-0.25 | | “trace” |
| 3 | >0.25-0.5 | ±3-4 | “little” |
| 4 | >0.5-1.0 | ±5-9 | “somewhat” |
| 5 | >1.0-2.0 | | “markedly” |
| 6 | >2.0-4.0 | ±10-20 | “distinctly” |
| 7 | >4.0 | >25 | “significantly” |

b) Use examples

### Example A1

10 g of the compound of example H1 and 50 g of Pigment Blue 60 were ground in the presence of 1.5 kg of grinding balls in a 0.6 liter vibrating mill from Siebentechnik for 20 hours. For comparison, 50 g of Pigment Blue 60 were ground under identical conditions without the dispersant. 15 g each of the pigment preparation according to the present invention and of the comparative sample were dispersed in the aqueous coating system as described under a) in the general prescription, and the properties were determined. The pigment preparation according to the present invention exhibited better dispersibility, a distinctly higher color strength after a dispersing time of 12 min, a markedly redder hue and a markedly cleaner hue compared with the comparative sample.

A dodecaethoxylated β-naphthol as described in EP-A 555 950 did not permit such a dry ball milling operation, since the compound of EP-A 555 950 is liquid.

### Example A2

25 g of the compound of example H4 were kneaded with 200 g of Pigment Red 179 which had been finished, ie optimized in its properties by crystallization, and had an average primary particle size of 50 nm and 250 ml of water in an Ilkavisc MKD0,6 laboratory kneader for 36 hours. The kneading viscosity required was adjusted by evaporating or adding water. The water was subsequently evaporated. For comparison, 200 g of Pigment Red 179 were ground under identical conditions without the dispersant. 15 g of the pigment preparation according to the present invention and 15 g of the comparative sample were each dispersed in the aqueous coating system as described under a) in the general prescription, and the properties were determined. The pigment preparation according to the present invention displayed a markedly higher color strength and a somewhat cleaner hue than the comparative sample without dispersant.

### Example A3

13.5 g of Pigment Blue 15:1 (average primary particle size 25 nm) were manually preblended with 1.5 g of the compound of example H7. This pigment preparation was dispersed in the above aqueous coating system as per the above general prescription, and the properties were determined. The coating according to the present invention exhibited a somewhat higher color strength and markedly higher chroma than a comparative coating which contained 15 g of the pigment and no compound according to the present invention.

### Example A4

100 g of Pigment Red 179 (average primary particle size 2 μm) were ground with 20 g of the compound of example H3 in the presence of 1.5 kg of steel grinding balls 3 cm in diameter in a planetary mill for 36 hours. For comparison, 120 g of Pigment Red 179 were ground under identical conditions without the dispersant. 15 g each of the pigment preparation according to the present invention and of the comparative sample were dispersed in the aqueous coating system as described under a) in the general prescription, and the properties were determined. The pigment preparation according to the present invention exhibited better dispersibility, a substantially higher color strength, a markedly cleaner hue and a somewhat yellower hue compared with the comparative sample without dispersant.

A dodecaethoxylated β-naphthol as described in EP-A 555 950 did not permit such a dry ball milling operation, since the compound of EP-A 555 950 is liquid.

### Example A5

20 g of Pigment Yellow 139 (average particle size 150 nm) were wet ground with 4 g of the compound of example H5 in 100 ml of water in the presence of 20 g of 3 mm glass balls in a Skandex shaker from Lau for 4 hours. After the glass balls had been filtered off, the suspension obtained was evaporated to dryness in a drying cabinet at 80° C. A granular product was obtained. 15 g of this granular product were redispersed in the aqueous coating system as described, and the properties were determined. The coating according to the present invention had a somewhat higher color strength, a somewhat greener hue and somewhat higher chroma after a dispersing time of 12 min and after a dispersing time of 120 min than a comparative composition without dispersant.

### Example A6

10 g of the compound of example H6 and 50 g of Pigment Green 7 were ground in the presence of 1.5 kg of 1 mm steel balls in a vibrating mill for 36 hours. For comparison, 60 g of Pigment Green 7 were ground under identical conditions without addition of dispersant. The two samples were dispersed in the aqueous coating system as per the abovementioned general prescription, and the properties were determined. The sample containing H6 had a distinctly higher color strength, a lower dispersibility (significantly higher color strength after a dispersing time of 12 minutes) and a little higher chroma than the comparative sample.

A dodecaethoxylated β-naphthol as described in EP-A 555 950 did not permit such a dry ball milling operation, since the compound of EP-A 555 950 is liquid.

### Example A7

20 g of Pigment Blue 60 in the form of a moist presscake were dispersed with 2 g of the compound of example H8 in a total of 100 ml of water in the presence of 20 g of 3 mm glass balls in a Skandex shaker from Lau for four hours. For comparison, a dodecaethoxylated β-naphthol, described in EP-A 555 950, was used in lieu of the compound of example H8. After the glass balls had been removed, the fluidic pigment suspension was dried at 80° C. The two samples were dispersed in the aqueous coating system in accordance with the above general description, and the properties were determined. The sample containing H8 had a somewhat higher color strength and a somewhat higher chroma.

### Example A8

20 g of the compound of example H2 were kneaded with 200 g of Pigment Red 179 which had been finished, ie optimized in its properties by crystallization, and had an average primary particle size of 150 nm and 250 ml of water in an Ilkavisc MKD0,6 laboratory kneader for 10 hours at 15° C. and 12 Nm torque. The kneading viscosity required was adjusted by evaporating or adding water. The water was subsequently evaporated. For comparison, 200 g of Pigment Red 179 were ground under identical conditions without the dispersant. 15 g of the pigment preparation according to the present invention and 15 g of the comparative sample were each dispersed in an aqueous coating system as described under a) in the general prescription, and the properties were determined. The pigment preparation according to the present invention displayed a markedly higher color strength and a somewhat cleaner hue than the comparative sample without dispersant.

1. Compounds of the general formulae I to III
R¹—X—[—CO—NH—R²—NH—CO—Y—R³—Y—]ᵣ—CO—NH—R²—NH—CO—X—R¹ (I)
R¹—X—[—CO—NH—R²—NH—CO—Y—R³—Y—]ᵣ—CO—NH—R⁴ (II)
R¹—X—[—CO—NH—R²—NH—CO—Y—R³—Y—]ᵣ—CO—NH—R²—NH—CO—Z—R⁵ (III)
were R¹ is an alkyl-capped oligoalkylene oxide radical of the general formula IV
R⁶O—(—CH₂—CH₂—O—)ₐ—(—R⁷—O—)_{b}— (IV)
where
X is O or NH
Y is O or NH
Z is O or NH
R² is an arylene or aralkylene radical of an aliphatic, aromatic or aromatic-aliphatic diisocyanate OCN—R²—NCO,
R³ is an alkylene, arylene or aralkylene radical of an aliphatic, aromatic or aromatic-aliphatic diol HO—R³—OH for Y being O or a diamine H₂N—R³—NH₂ for Y being NH,
R⁴ is an alkyl, aryl or aralkyl radical of an aliphatic, aromatic or aromatic-aliphatic monoisocyanate R⁴—NCO,
R⁵ is an alkyl, aryl or aralkyl radical of an aliphatic, aromatic or aromatic-aliphatic monoalcohol R⁵—OH for Z being O or a monoamine R⁵—NH₂ for Z being NH,
R⁶ is alkyl of 1 to 4 carbon atoms,
R⁷ is branched alkylene of 3 to 8 carbon atoms,
r is a rational number from zero to 100,
a is an integer from 1 to 300, and
b is an integer from zero to 30.

2. Compounds as claimed in claim 1, wherein R⁶ is methyl.

3. Compounds as claimed in claim 1, wherein r is zero.

4. Compounds as claimed in claim 1, wherein R² is selected from the group consisting of —(—CH₂—)₆—,

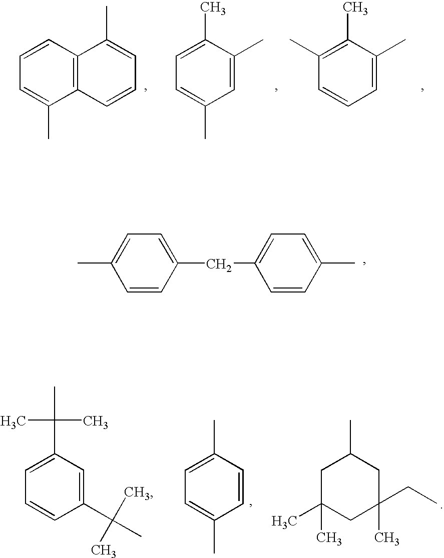

5. Compounds as claimed in claim 1, wherein R³ is selected from the group consisting of

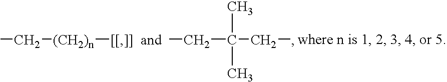

6. Compounds as claimed in claim 1, wherein a is an integer from 1 to 300 and b is zero.

7. A process for preparing a compound of the formula I claimed in claim 1, which comprises reacting a diisocyanate OCN—R²—NCO with a diol HO—R³—OH, when Y is O or with a diamine H₂N—R³—NH₂, when Y is NH and with an alkyl-capped oligoalkylene oxide of the general formula IVa when X is O,
R⁶O—(—CH₂—CH₂—O—)ₐ—(—R⁷—O—)_{b}—OH (IVa)
or the general formula IVb when X is NH,
R⁶O—(—CH₂—CH₂—O—)ₐ—(—R⁷—O—)_{b}—NH₂ (IVb).

8. A process for preparing a compound of the formula II as claimed in claim 1, which comprises reacting a diisocyanate OCN—R²—NCO with a diol HO—R³—OH, when Y is O or with a diamine H₂N—R³—NH₂, when Y is NH and with an alkyl-capped oligoalkylene oxide of the general formula IV when X is O,
R⁶O—(—CH₂—CH₂—O—)ₐ—(—R⁷—O—)_{b}—OH (IVa)
of the general formula IVb when X is NH,
R⁶O—(—CH₂—CH₂—O—)ₐ—(—R⁷—O—)_{b}—NH₂ (IVb)
and also with a monoisocyanate R⁴—NCO.

9. A process for preparing a compound of the formula III as claimed in claim 1, which comprises reacting a diisocyanate OCN—R²—NCO with a diol HO—R³—OH, when Y is O or with a diamine H₂N—R³—NH₂, when Y is NH and with an alkyl-capped oligoalkylene oxide of the general formula IV when X is O,
R⁶O—(—CH₂—CH₂—O—)ₐ—(—R⁷—O—)_{b}—OH (IVa)
or of the general formula IVb when X is NH,
R⁶O—(—CH₂—CH₂—O—)ₐ—(—R⁷—O—)_{b}—NH₂ (IVb)
and also, when Z is O, with a monoalcohol R⁵—OH or, when Z is NH, with a monoamine R⁵—NH₂.

10. A method of using, which comprises:
combining at least one compound of claim 1 with at least one pigment.

11. (Cancelled).

12. Pigment preparations comprising:
at least one compound as claimed in claim 1,
at least one inorganic or organic pigment and optionally water.

13-14. (Cancelled).

15. Water-containing coatings, water-containing printing inks, water-containing paints and waterborne coatings including pigment preparations as claimed in claim 12.

16. A water-containing coating, ink, or paint, comprising:
at least one compound as claimed in claim 1
at least one inorganic or organic pigment and optionally water.

17. A waterborne coating, comprising:
at least one compound as claimed in claim 1
at least one inorganic or organic pigment and optionally water.
